(19) United States
(12) Patent Application Publication
(10) Pub. No.: US 2018/0191218 A1
(43) Pub. Date: Jul. 5, 2018

(54) ELECTRIC MOTOR

(71) Applicant: INDUSTRIAL TECHNOLOGY RESEARCH INSTITUTE, Hsinchu (TW)

(72) Inventors: Shao-Yu LEE, Hsinchu County (TW); Kao-Hone CHU, Kaohsiung City (TW); Shih-Kai HSIEH, Taoyuan City (TW); Tung-Yu LI, Kaohsiung City (TW)

(73) Assignee: INDUSTRIAL TECHNOLOGY RESEARCH INSTITUTE, Hsinchu (TW)

(21) Appl. No.: 15/448,435

(22) Filed: Mar. 2, 2017

(30) Foreign Application Priority Data
Dec. 30, 2016 (TW) 105144242

(51) Int. Cl. H02K 3/24

(52) U.S. Cl. CPC H02K 3/24

(57) ABSTRACT

An electric motor includes a casing, a stator, a rotor and a first coolant guiding structure. The stator is stored in a storage space of the casing. The stator includes a stator yoke and winding sets. The stator yoke has first side, second side, annular external surface and guiding channel. The first coolant guiding structure is disposed close to the winding sets and an inlet channel. The first coolant guiding structure has first radially guiding channel and first axially guiding channel. Two ends of the first radially guiding channel respectively have a first radial inlet and a first radial outlet. The first radial inlet is connected to the first axially guiding channel in order to receive coolant from the first axially guiding channel. The first radial outlet is aligned with at least one of the winding sets in order to supply coolant to the winding sets.

### CROSS-REFERENCE TO RELATED APPLICATIONS

This non-provisional application claims priority under 35 U.S.C. § 119(a) on Patent Application No(s). 105144242 filed in Taiwan, R.O.C. on Dec. 30, 2016, the entire contents of which are hereby incorporated by reference.

### TECHNICAL FIELD

The disclosure relates to an electric motor, more particularly to an electric motor having coolant guiding channels.

### BACKGROUND

Electric motors can convert electrical energy into mechanical energy through electromagnetic interactions. The electric motors are widely used in daily life and applied to many fields. For example, the electric motors can be applied to machine tools, water pumps, light machinery, wind power systems, hydroelectric power generation systems and the like. The electric motors are fundamental to industry and closely linked with economic development.

During the operation of a conventional electric motor, windings generate the most amount of heat among all the components in the electric motor. The heat generated by the windings is the main energy loss in electric motor because winding end turns of the windings protruding from a stator are not directly in contact with a casing of the electric motor, so that the thermal impedance of the winding end turns is high, and heat on the winding end turns is not able to be transferred. As a result, heat is accumulated at the winding end turns, and thus the temperature of the winding end turns becomes the highest in the electric motor. The increase of heat on the winding end turns raises the temperature of the electric motor, but it reduces the power output of the electric motor and results in malfunction. Accordingly, the overly high temperature of the winding end turns of the stator becomes an important issue to be solved in this field.

Conventionally, there are two ways to remove heat generated by the winding end turns of the stator:

In the first way, a shaft inside a rotor is drilled with many through holes, some of the through holes are parallel to an axial direction of the shaft, and the other through holes are parallel to radial directions of the shaft. Coolant is supplied into the shaft, so it can be sprayed to the winding end turns of the stator for cooling while the shaft is rotated by the rotor.

In the second way, it provides a stator cooling jacket to be mounted on the outer surface of the stator and between the stator and the casing, and the cooling jacket is drilled with axial and radial holes connected to a coolant supply, so that coolant can be sprayed on the winding end turns of the stator for cooling.

### SUMMARY

One embodiment of the disclosure provides an electric motor including a casing, a stator, a rotor and a first coolant guiding structure. The casing has a storage space. The stator is stored in the storage space. The stator includes a stator yoke and a plurality of winding sets. The stator yoke has a first side, a second side, an annular external surface and at least one guiding channel. The first side and the second side are opposite to each other. The annular external surface is located between the first side and the second side. The winding sets are wound on the stator yoke and protrude from the first side and the second side of the stator yoke. The at least one guiding channel of the stator yoke is formed on the annular external surface and extends from the first side to the second side. The rotor is rotatably disposed in the stator yoke. The first coolant guiding structure is disposed close to the plurality of winding sets of the stator and an inlet channel of the casing. The first coolant guiding structure has at least one first radially guiding channel and at least one first axially guiding channel. The at least one first axially guiding channel is connected to the inlet channel and the casing and the at least one guiding channel of the stator yoke in order to receive and guide coolant into the at least one guiding channel of the stator yoke. Two ends of the at least one first radially guiding channel, which are opposite to each other, respectively have a first radial inlet and a first radial outlet. The first radial inlet is connected to the at least one first axially guiding channel in order to receive coolant from the at least one first axially guiding channel. The first radial outlet is aligned with at least one of the plurality of winding sets in order to supply coolant to the plurality of winding sets.

One embodiment of the disclosure provides an electric motor including a casing, a stator, a rotor and a first coolant guiding structure. The casing has a storage space and at least one guiding channel. The at least one guiding channel of the casing is located at a side of the storage space. The stator is stored in the storage space. The stator includes a stator yoke and a plurality winding sets. The stator yoke has a first side, a second side and an annular external surface. The first side and the second side are opposite to each other. The annular external surface is located between the first side and the second side. The winding sets are wound on the stator yoke and protrude from the first side and the second side of the stator yoke. The at least one guiding channel of the casing is located close to the annular external surface, and the at least one guiding channel extends from a part of the plurality of winding sets protruding from the first side to another part of the plurality of winding sets protruding from the second side. The rotor is rotatably disposed in the stator yoke. The first coolant guiding structure is disposed close to the plurality of winding sets of the stator and an inlet channel of the casing. The first coolant guiding structure has at least one first radially guiding channel and at least one first axially guiding channel. The at least one first axially guiding channel is connected to the inlet channel of the casing and the at least one guiding channel of the casing in order to receive and guide coolant into the at least one guiding channel of the casing. Two ends of the at least one first radially guiding channel, which are opposite to each other, each has a first radial inlet and a first radial outlet. The first radial inlet is connected to the at least one first axially guiding channel in order to receive coolant from the at least one first axially guiding channel. The first radially guiding channel is aligned with at least one of the plurality of winding sets in order to supply coolant to the plurality of winding sets.

### BRIEF DESCRIPTION OF THE DRAWINGS

The present disclosure will become better understood from the detailed description given hereinbelow and the accompanying drawings which are given by way of illustration only and thus are not limitative to the present disclosure and wherein:

FIG. 1 is a perspective view of an electric motor according to one embodiment of the disclosure;

FIG. 2 is an exploded view of the electric motor in FIG. 1;

FIG. 3 is a partial exploded view of the electric motor in FIG. 1;

FIG. 4 is a cross-sectional view of the electric motor in FIG. 1;

FIG. 5 is a partial enlarged view of a first coolant guiding structure in FIG. 2;

FIG. 6 is a partial enlarged view of a second coolant guiding structure in FIG. 2;

FIG. 7 is a partial enlarged view of an electric motor according to another embodiment of the disclosure; and

FIG. 8 is a cross-sectional view of an electric motor according to yet another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the following embodiments are disclosed by the figures, and some practical details are described in the following paragraphs, but the present disclosure is not limited thereto. Furthermore, for the purpose of illustration, some of the structures and components in the figures are simplified, and wires, lines or buses are omitted in some of the figures.

Moreover, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

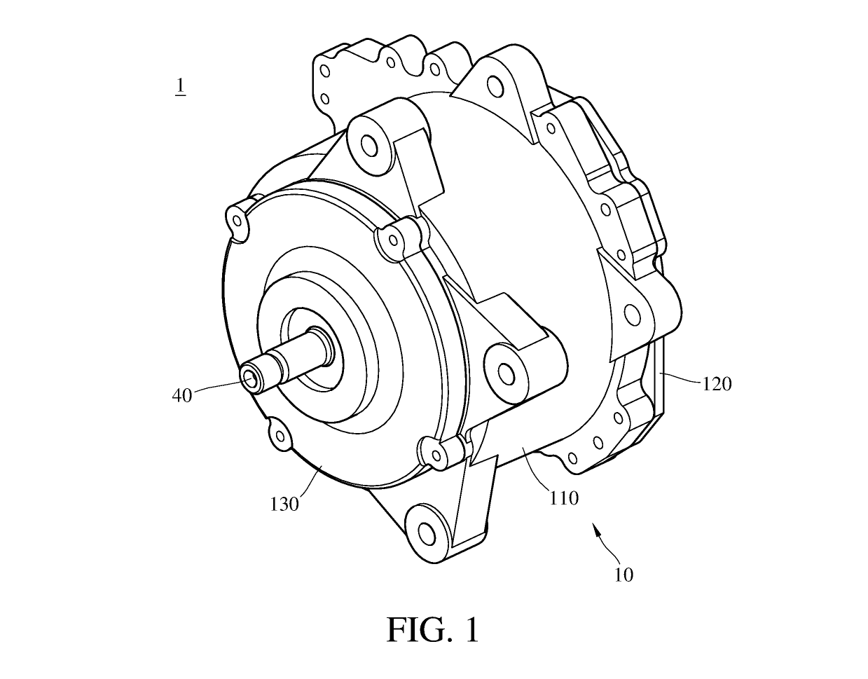

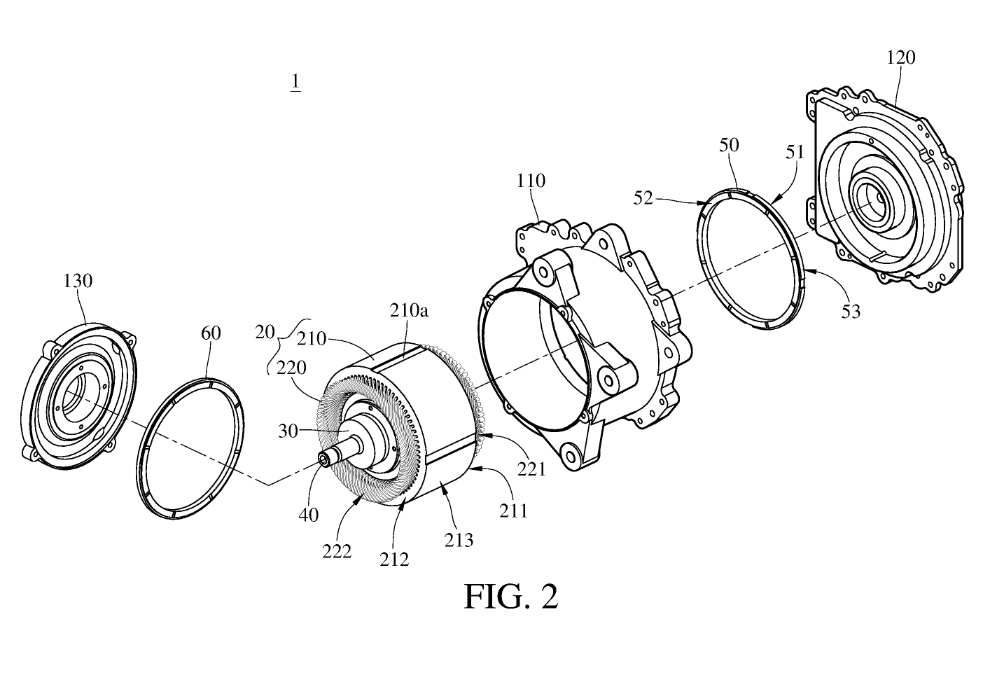

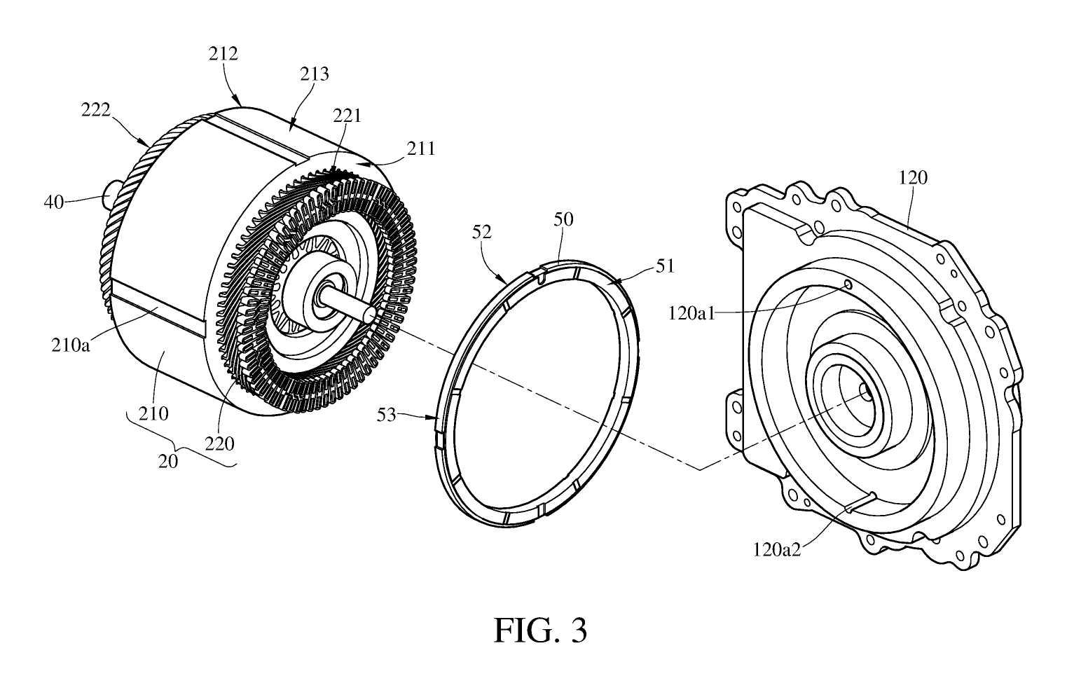

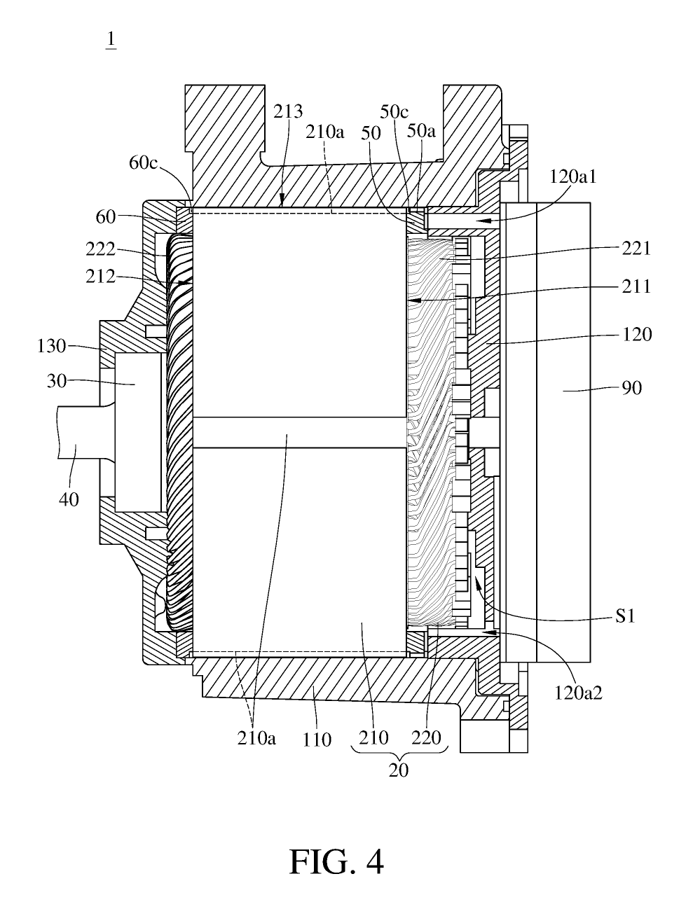

Please refer to FIGS. 1 to 4. FIG. 1 is a perspective view of an electric motor according to one embodiment of the disclosure; FIG. 2 is an exploded view of the electric motor in FIG. 1; FIG. 3 is a partial exploded view of the electric motor in FIG. 1; and FIG. 4 is a cross-sectional view of the electric motor in FIG. 1.

According to one embodiment of the disclosure, an electric motor 1 is provided. The electric motor 1 is additionally mounted with a coolant supply 90. The coolant supply 90 is able to supply coolant for cooling the electric motor 1. In this embodiment, the electric motor 1 includes a casing 10, a stator 20, a rotor 30, a shaft 40, a first coolant guiding structure 50 and a second coolant guiding structure 60.

The casing 10 includes a main part 110, an end cover 120 and an end cover 130. The main part 110 is a barrel-shaped structure having two openings at both ends. During assembly process, the stator 20, the rotor 30, the shaft 40, the first coolant guiding structure 50, the second coolant guiding structure 60 and other required components are able to be stored into a storage space 51 of the casing 10 via one of the opening, and the end covers 120 and 130 are respectively detachably mounted on two opposite sides of the main part 110 to seal the two openings. In this embodiment, the main part 110, the end cover 120 and the end cover 130 together form the storage space S1 of the casing 10, but the present disclosure is not limited to the configuration of the casing 10. In some embodiments, the main part of the casing may be a barrel-shaped structure having only one opening at one end; in such a case, the casing has only one end cover.

In addition, in this embodiment, the end cover 120 has an inlet channel 120a1 and an outlet channel 120a2. The coolant supply 90 is mounted on a side of the end cover 120 facing away from the main part 110. The coolant supply 90 is connected to the inlet channel 120a1 and the outlet channel 120a2. The coolant supply 90 is able to store and supply coolant, it includes coolant, a coolant pump, a heat exchanger, piping (all not shown) and other components. The coolant pump is connected to the inlet channel 120a1 and the outlet channel 120a2 in order to inject coolant into the storage space S1 via the inlet channel 120a1 and withdraw the coolant from the storage space S1 via the outlet channel 120a2, so that the heat exchanger can remove heat from the coolant. The coolant is made of an electrically insulating material which is able to be directly in contact with the stator 20 and the rotor 30. Therefore, it is understood that the coolant is cooling oil.

The present disclosure is not limited to the locations of the inlet channel 120a1, the outlet channel 120a2 and the coolant supply 90. In some embodiments, the coolant supply may be mounted on another end cover of the main part of the casing; or mounted on an annular side surface of the main part of the casing; in such a case, the inlet channel and the outlet channel are formed at the main part of the casing.

The stator 20 includes a stator yoke 210 and a plurality of winding sets 220. The stator yoke 210 is fixed to an inner wall of the main part 110 of the casing 10. The stator yoke 210, also called stator core, is, for example, a structure including a lamination of a plurality of silicon steel sheets. The stator yoke 210 has a first side 211, a second side 212, an annular external surface 213 and four guiding channels 210a. The first side 211 and the second side 212 are opposite to each other, the first side 211 is a side of the stator yoke 210 facing the coolant supply 90, and the second side 212 is a side of the stator yoke 210 facing away from the coolant supply 90. The annular external surface 213 is between the first side 211 and the second side 212. The guiding channels 210a are formed on the annular external surface 213, and extend from the first side 211 to the second side 212.

In this embodiment, each guiding channel 210a is a straight channel, and an extension direction of each guiding channel 210a is parallel to an axial direction of the stator 20, but the present disclosure is not limited thereto. In some embodiments, each guiding channel of the stator yoke may be a curved channel extending along the annular external surface of the stator yoke.

In addition, the present disclosure is not limited to the quantity of the guiding channels of the stator yoke. In some embodiments, the stator yoke may have only one or more than four guiding channels.

Each winding set 220 is made of, for example, copper. The winding sets 220 are wound on the stator yoke 210, and protrude from the first side 211 and the second side 212 of the stator yoke 210. In this embodiment, the parts of the winding sets 220 protruding from the first side 211 of the stator yoke 210 forms multiple winding end turns 221, and other parts of the winding sets 220 protruding from the second side 212 of the stator yoke 210 form multiple winding end turns 222.

The rotor 30 is rotatably disposed in the stator yoke 210.

The shaft 40, also called output shaft or transmission shaft, is mounted on the rotor 30. The shaft 40 is able to be jointly rotated with the rotor 30 in order to output the rotational driving force of the rotor 30.

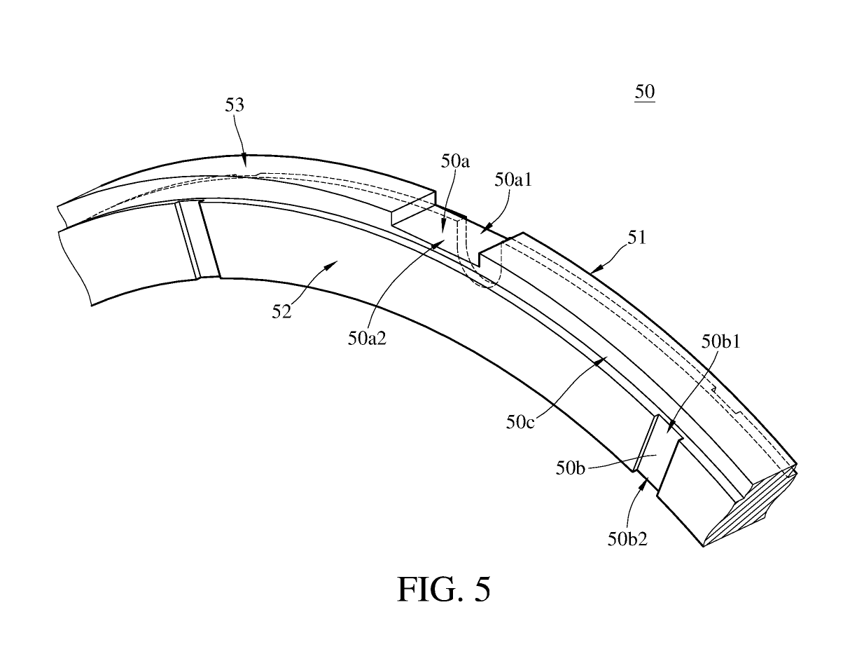

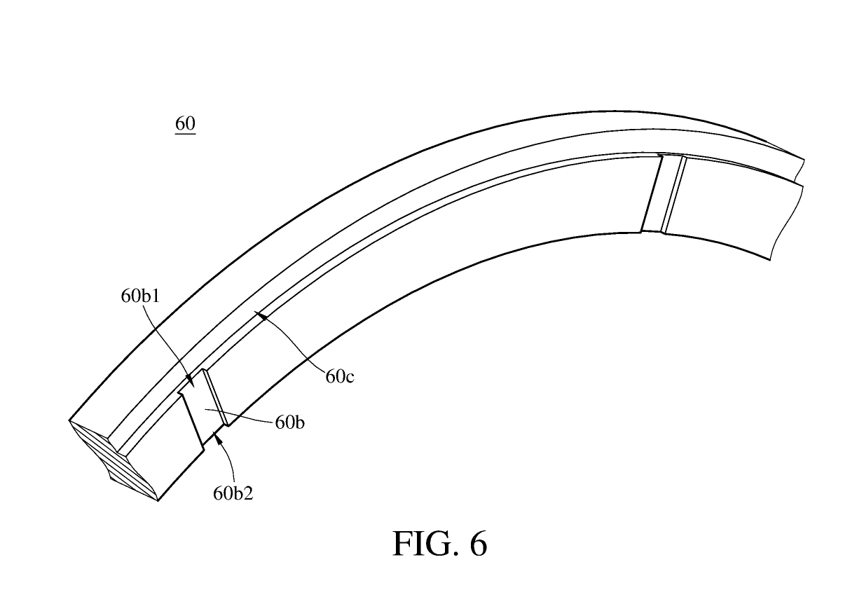

Please refer to FIGS. 2 to 3 and further refer to FIGS. 5 to 6. FIG. 5 is a partial enlarged view of a first coolant guiding structure in FIG. 2; and FIG. 6 is a partial enlarged view of a second coolant guiding structure in FIG. 2.

The first coolant guiding structure 50 is a ring-shaped object. The first coolant guiding structure 50 surrounds the winding end turns 221 of the winding sets 220, and is located close to the inlet channel 120a1 on the end cover 120. In this embodiment, the first coolant guiding structure 50 has a first side 51, a second side 52, an annular external surface 53, four first axially guiding channels 50a, sixteen first radially guiding channels 50b and two first connecting guiding channels 50c.

In detail, the first side 51 and the second side 52 are opposite to each other. The first side 51 is a side of the first coolant guiding structure 50 facing away from the stator yoke 210, and the second side 52 is another side of the first coolant guiding structure 50 facing the stator yoke 210. The annular external surface 53 is between the first side 51 and the second side 52. The first axially guiding channels 50a are formed on the annular external surface 53, and extend from the first side 51 to the second side 52.

Each first axially guiding channel 50a has a first end 50a1 and a second end 50a2, which are respectively located at the first side 51 and the second side 52. Therefore, it is understood that the first end 50a1 is an opening of the first axially guiding channel 50a facing away from the stator yoke 210; that is, the first end 50a1 is an opening of the first axially guiding channel 50a close to the coolant supply 90. The second end 50a2 is another opening of the first axially guiding channel 50a close to the stator yoke 210; that is, the second end 50a2 is another opening of the first axially guiding channel 50a facing away from the coolant supply 90. In this embodiment, the first axially guiding channel 50a is used to receive coolant from the coolant supply 90. In more detail, the first end 50a1 of one of the first axially guiding channels 50a relatively close to the inlet channel 120a1 is connected to a notch (not numbered) in order to receive coolant from the coolant supply 90.

The first radially guiding channels 50b are divided into two groups. Each of the groups has eight first radially guiding channels 50b, and the two groups are respectively located at the first side 51 and the second side 52. Each first radially guiding channel 50b has a first radial inlet 50b1 and a first radial outlet 50b2. The first radial inlet 50b1 is closer to the annular external surface 53 than the first radial outlet 50b2 is to the annular external surface 53. The first radial outlet 50b2 is aligned with at least one of the winding end turns 221 of the winding sets 220.

The first connecting guiding channels 50c are respectively located at the first side 51 and the second side 52. Each first connecting guiding channel 50c is in a ring shape, and is located between and connected to the first axially guiding channels 50a and the first radially guiding channels 50b. In this embodiment, the quantity of the first axially guiding channels 50a is different from the quantity of the first radially guiding channels 50b, and the locations of the first axially guiding channels 50a do not correspond to the locations of the first radially guiding channels 50b, and thus, in this embodiment, the first axially guiding channels 50a are connected to the first radially guiding channel 50b through the first connecting guiding channels 50c, so that coolant transmitted from the first axially guiding channels 50a are able to be guided into the first radially guiding channels 50b through the first connecting guiding channels 50c.

In addition, as shown in Figures, the quantity of the first axially guiding channels 50a of the first coolant guiding structure 50 is the same as the quantity of the guiding channels 210a of the stator yoke 210, and the locations of the first axially guiding channels 50a correspond to the locations of the guiding channels 210a; that is, the first axially guiding channels 50a are aligned with the guiding channels 210a, but the present disclosure is not limited thereto. In some embodiments, the first axially guiding channels of the first coolant guiding structure may not be aligned with the guiding channel of the stator yoke; in such a case, a side of the first coolant guiding structure close to the stator yoke is required to have the first connecting guiding channel, in order to guide coolant from the first axially guiding channels of the first coolant guiding structure into the guiding channels of the stator yoke.

The second coolant guiding structure 60 is a ring-shaped object. The second coolant guiding structure 60 surrounds the winding end turns 222 of the winding sets 220, and is located close to a side of the winding sets 220 facing away from the first coolant guiding structure 50. In this embodiment, the second coolant guiding structure 60 has eight second radially guiding channels 60b and a second connecting guiding channel 60c.

The second connecting guiding channel 60c is in a ring shape, and is located at a side of the second coolant guiding structure 60 facing the stator yoke 210; that is, the second connecting guiding channel 60c is located at a side of the second coolant guiding structure 60 close to the guiding channels 210a of the stator yoke. The second connecting guiding channel 60c is connected to the guiding channels 210a in order to receive coolant from the guiding channels 210a.

In this embodiment, the quantity of the second radially guiding channels 60b is different from the quantity of the guiding channels 210a of the stator yoke 210, and the locations of the second radially guiding channels 60b do not correspond to the locations of the guiding channels 210a, so that the second radially guiding channels 60b are connected to the guiding channels 210a through the second connecting guiding channel 60c, but the present disclosure is not limited thereto. In some embodiments, the quantity of the second radially guiding channels may be the same as the quantity of the guiding channels of the stator yoke, and the second radially guiding channels may be aligned with the guiding channels of the stator yoke; in such a case, the second coolant guiding structure may have no second connecting guiding channel, and the second radially guiding channels are able to be directly connected to the guiding channels of the stator yoke. In more detail, each second radially guiding channel 60b has a second radial inlet 60b1 and a second radial outlet 60b2.

The second radial outlet 60b2 is aligned with at least one of the winding end turns 222 of the winding sets 220 in order to provide coolant to the winding end turns 222.

Then, the operation of the electric motor 1 is described in the following paragraphs. Please refer to FIG. 4 and also refer to FIGS. 2 to 3 and 5 to 6.

During the operation of the electric motor 1, the stator winding sets 220 receive electricity, and the rotor 30 is rotated according to the interaction with the stator 20, and the shaft 40 is jointly rotated with the rotor 30 in order to output the rotational driving force of the rotor 30.

In the meantime, the coolant pump (not shown) in the coolant supply 90 is activated, so that coolant is injected into the storage space S1 from the inlet channel 120a1 of the end cover 120. Since the first coolant guiding structure 50 surrounds the winding end turns 221 of the winding sets 220, and is located close to the inlet channel 120a1 of the casing 10, coolant from the inlet channel 120a1 is directly guided by the first axially guiding channels 50a of the first coolant guiding structure 50 so as to flow into the first connecting guiding channels 50c at two sides (the first side 51 and the second side 52) of the first coolant guiding structure 50, and then coolant is guided into the first radially guiding channels 50b through the first connecting guiding channels 50c. Since the first radial outlet 50b2 of each first radially guiding channel 50b is aligned with at least one of the winding end turns 221 of the winding sets 220, part of coolant from the first radially guiding channels 50b is directly supplied (poured or sprayed) on the aligned winding end turns 221 for absorbing heat on the winding end turns 221. The other part of coolant is guided into the guiding channels 210a of the stator yoke 210, and then flows to the second coolant guiding structure 60 by the guide of the guiding channels 210a. Then, coolant from the guiding channels 210a is guided by the second connecting guiding channel 60c of the second coolant guiding structure 60 so as to flow into the second radially guiding channels 60b. Since the second radial outlet 60b2 of each second radially guiding channel 60b is aligned with at least one of the winding end turns 222 of the winding sets 220, coolant from the second radially guiding channels 60b is directly supplied (poured or sprayed) to the aligned winding end turn 222 for absorbing heat on the winding end turns 222.

Accordingly, coolant flows down along the winding end turns 221 and 222, and then is drawn back to the coolant supply 90 through the outlet channel 120a2 at the end cover 120 for the next circulation by the coolant pump (not shown) of the coolant supply 90.

In short, coolant is able to be directly supplied to the winding end turns 221 and 222 through the guiding channels on the first coolant guiding structure 50, the stator yoke 210 and the second coolant guiding structure 60. In other words, coolant is able to be supplied to the main heat sources of the electric motor 1 (i.e. the winding end turns 221 and 222 of the winding sets 220) by the first coolant guiding structure 50, the stator yoke 210 and the second coolant guiding structure 60, which is favorable for improving cooling efficiency.

In addition, the present disclosure is not limited to the quantities and locations of the first axially guiding channels, the first radially guiding channels and the first connecting guiding channels of the first coolant guiding structure. In some embodiments, the first coolant guiding structure may have only one first axially guiding channel, one first radially guiding channel and one first connecting guiding channel, and the first radially guiding channel and the first connecting guiding channel are both located at the same side of the first coolant guiding structure, e.g. the side of the first coolant guiding structure facing the guiding channels of the stator yoke. Furthermore, in this embodiment, the quantity of the first axially guiding channels 50a is different from the quantity of the first radially guiding channels 50b, and the locations of the first axially guiding channels 50a do not correspond to the locations of the first radially guiding channels 50b, but the present disclosure is not limited thereto. In some embodiments, the quantity of the first axially guiding channels may be the same as the quantity of the first radially guiding channels, and the first axially guiding channels may be aligned with the first radially guiding channels.

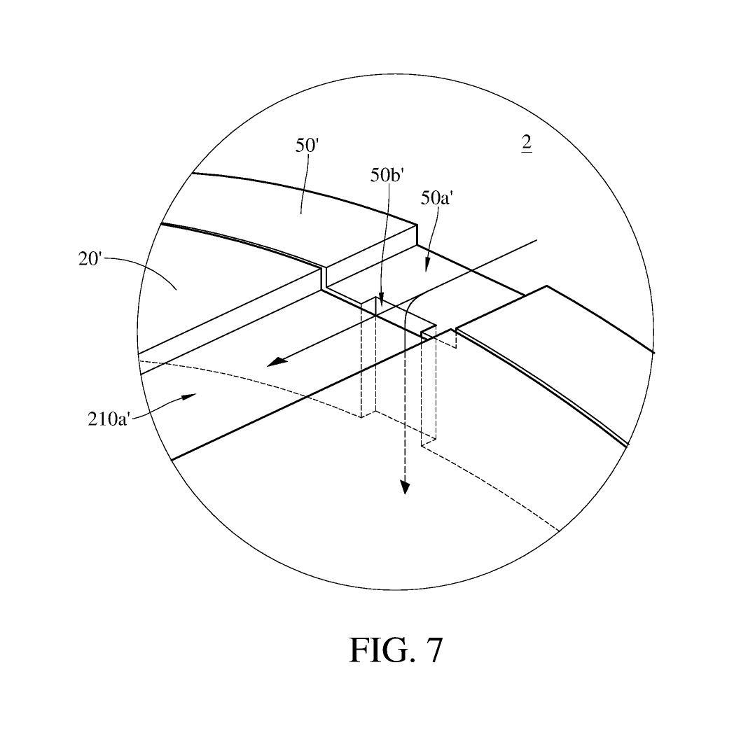

For example, please refer to FIG. 7. FIG. 7 shows a partial enlarged view of an electric motor 2 of another embodiment of the disclosure, but the configuration of the electric motor 2 is similar to that of the electric motor 1, so only the differences between the two embodiments are described. In addition, for the purpose of clear illustration, some components that are not mentioned in this embodiment are omitted in FIG. 7, e.g. the second coolant guiding structure 60 of the aforementioned embodiment is omitted in FIG. 7.

FIG. 7 only shows a stator 20′ and a first coolant guiding structure 50′, and the first coolant guiding structure 50′ is configured for receiving coolant. In detail, the first coolant guiding structure 50′ has only one first axially guiding channel 50a′ and one first radially guiding channel 50b′, and the stator 20′ has only one guiding channel 210a′. Both the first axially guiding channel 50a′ and the first radially guiding channel 50b′ of the first coolant guiding structure 50′ and the guiding channel 210a′ of the stator 20′ are connected to and aligned with one another.

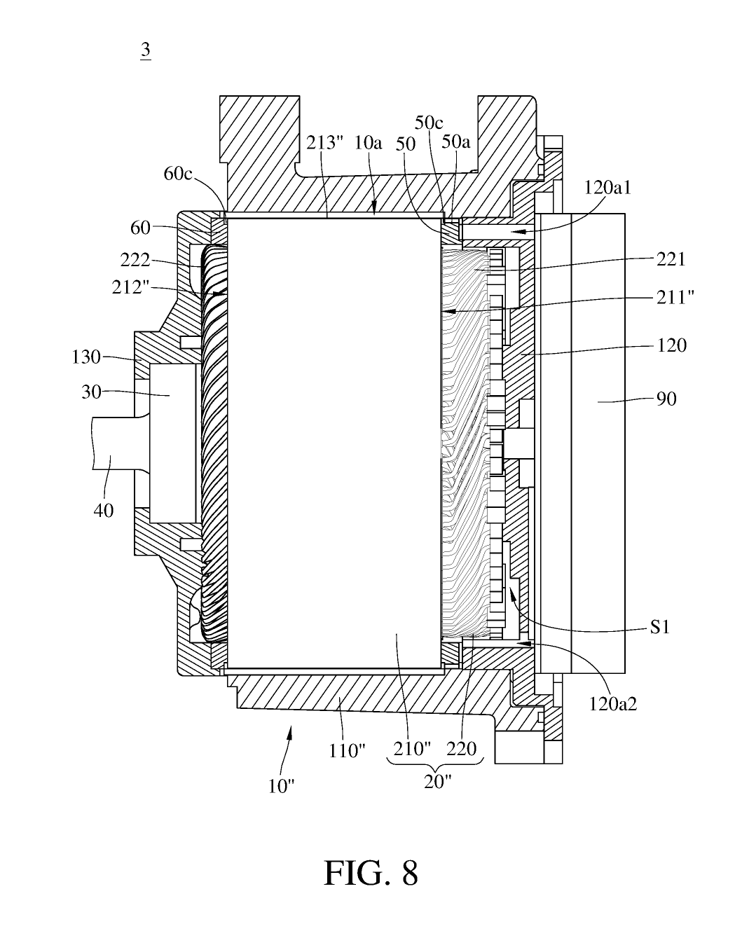

In addition, in the aforementioned embodiments, although the stator has one or more guiding channels for receiving coolant from the first coolant guiding structure and is able to guide coolant to the second coolant guiding structure, but the present disclosure is not limited thereto. For example, please refer to FIG. 8, which is a cross-sectional view of an electric motor 3 according to yet another embodiment of the disclosure, but the configuration of the electric motor 3 is similar to that of the electric motor 1, so only the differences between the two embodiments are described. The electric motor 3 has a stator yoke 210″ and a casing 10″. The stator yoke 210″ has no aforementioned guiding channel 210a, but an inner surface of a main part 110″ of the casing 10″ has more than one guiding channel 10a. The guiding channels 10a are located close to an annular external surface 213″ of the stator yoke 210″, and extend from one side of the winding sets 220 protruding from a first side 211″ of a stator yoke 210″ to another side of the winding sets 220 protruding from a second side 212″ of the stator yoke 210″. Two opposite sides of the guiding channel 10a are respectively connected to one of the first axially guiding channels 50a of the first coolant guiding structure 50 and one of the second radially guiding channels 60b of the second coolant guiding structure 60, wherein the guiding channel 10a is connected to the second radially guiding channel 60b via the second connecting guiding channel 60c. Therefore, coolant is able to be guided from one side of the stator yoke 210″ to another side of the stator yoke 210″ through the guiding channels 10a of the casing 10″. In addition, the present disclosure is not limited to the quantity of the guiding channels 10a. In some embodiments, the casing may have only one guiding channel. Furthermore, in this and other embodiments, the second coolant guiding structure 60 is optional according to actual requirements, and the present disclosure is not limited thereto.

Moreover, the present disclosure is not limited to the quantity of the second radially guiding channels of the second coolant guiding structure. In some embodiments, the second coolant guiding structure may have only one second radially guiding channel.

In the aforementioned embodiments, although the first coolant guiding structure 50 and the second coolant guiding structure 60 are both ring-shaped objects, but the present disclosure is not limited thereto. In some embodiments, each of the first coolant guiding structure and the second coolant guiding structure may be a one-quarter ring-shaped or three-quarters ring-shaped object; in such a case, the first coolant guiding structure and the second coolant guiding structure are close to the winding sets of the stator.

In some embodiments, the first coolant guiding structure, the second coolant guiding structure and the casing are integral with one another; in other words, the first coolant guiding structure and the second coolant guiding structure are two protrusions protruding from the inner surface of the casing, but the present disclosure is not limited thereto.

According to one embodiment of the electric motor as discussed above, coolant is able to be directly supplied to the winding sets protruding from two sides of the stator yoke through the first radially guiding channel and the first axially guiding channel of the first coolant guiding structure and the guiding channel of the stator yoke or the casing. In particularly, the first coolant guiding structure and the guiding channels on the stator yoke and the casing are easy to make, it can be formed by one step without additional process, and the cost of making them is low. Therefore, the electric motor is able to be efficiently cooled without additionally equipping a cooling jacket on the casing or drilling the casing. In other words, the electric motor of the present disclosure is low in cost, has no leakage of coolant, and forms coolant channels for cooling with a non-destructive manner.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An electric motor, comprising:
a casing, having a storage space;
a stator, being stored in the storage space, the stator comprising a stator yoke and a plurality of winding sets, the stator yoke having a first side, a second side, an annular external surface and at least one guiding channel, the first side and the second side opposite to each other, the annular external surface located between the first side and the second side, the plurality of winding sets wound on the stator yoke and protruding from the first side and the second side of the stator yoke, and the at least one guiding channel of the stator yoke being formed on the annular external surface and extending from the first side to the second side;
a rotor, being rotatably disposed in the stator yoke; and
a first coolant guiding structure, being disposed close to the plurality of winding sets of the stator and an inlet channel of the casing, the first coolant guiding structure having at least one first radially guiding channel and at least one first axially guiding channel, the at least one first axially guiding channel connected to the inlet channel of the casing and the at least one guiding channel of the stator yoke in order to receive and guide coolant into the at least one guiding channel of the stator yoke, two ends of the at least one first radially guiding channel, which are opposite to each other, respectively having a first radial inlet and a first radial outlet, the first radial inlet connected to the at least one first axially guiding channel in order to receive coolant from the at least one first axially guiding channel, and the first radial outlet aligned with at least one of the plurality of winding sets in order to supply coolant to the plurality of winding sets.

2. The electric motor according to claim 1, wherein the first coolant guiding structure further has at least one first connecting guiding channel, the at least one first connecting guiding channel is connected to one end of the at least one first axially guiding channel and the first radial inlet of the at least one first radially guiding channel.

3. The electric motor according to claim 2, wherein the at least one first connecting guiding channel is located at a side of the first coolant guiding structure facing or facing away from the stator yoke.

4. The electric motor according to claim 2, wherein the quantity of the at least one guiding channel of the stator yoke is plural, the quantity of the at least one first axially guiding channel of the first coolant guiding structure is plural, the first radial inlet of the at least one first radially guiding channel is connected to the first axially guiding channels through the at least one first connecting guiding channel, and the guiding channels of the stator yoke are connected to the first axially guiding channels through the at least one first connecting guiding channel.

5. The electric motor according to claim 2, wherein the quantity of the at least one first radially guiding channel of the first coolant guiding structure is plural, and the at least one first axially guiding channel is connected to the first radial inlets of the first radially guiding channels through the at least one first connecting guiding channel.

6. The electric motor according to claim 5, wherein the quantity of the at least one first connecting guiding channel is two, the two first connecting guiding channels are respectively located at two sides of the first coolant guiding structure opposite to each other, and the two opposite sides of the first coolant guiding structure respectively have the first radially guiding channels.

7. The electric motor according to claim 1, wherein the at least one guiding channel of the stator yoke, the at least one first axially guiding channel and the at least one first radially guiding channel of the first coolant guiding structure are connected to and aligned with one another.

8. The electric motor according to claim 1, wherein the first coolant guiding structure and the casing are integral with each other.

9. The electric motor according to claim 1, further comprising a second coolant guiding structure, being disposed close to a side of the plurality of winding sets of the stator facing away from the first coolant guiding structure, the second coolant guiding structure having at least one second radially guiding channel, the at least one second radially guiding channel having a second radial inlet and a second radial outlet, the second radial inlet connected to the at least one guiding channel of the stator yoke in order to receive coolant from the at least one guiding channel of the stator yoke, and the second radial outlet aligned with at least one of the plurality of winding sets in order to supply coolant to the plurality of winding sets.

10. The electric motor according to claim 9, wherein the quantity of the at least one second radially guiding channel of the second coolant guiding structure and the quantity of the at least one guiding channel of the stator yoke are both plurals, and the guiding channels of the stator yoke are respectively aligned with the second radially guiding channels of the second coolant guiding structure.

11. The electric motor according to claim 9, wherein the second coolant guiding structure further has a second connecting guiding channel, the quantity of the at least one second radially guiding channel of the second coolant guiding structure and the quantity of the at least one guiding channel of the stator yoke are both plurals, and the second radial inlets of the second radially guiding channels are connected to the guiding channels of the stator yoke through the second connecting guiding channel.

12. The electric motor according to claim 9, wherein the second coolant guiding structure and the casing are integral with each other.

13. An electric motor, comprising:
a casing, having a storage space and at least one guiding channel, and the at least one guiding channel of the casing located at a side of the storage space;
a stator, being stored in the storage space, the stator comprising a stator yoke and a plurality winding sets, the stator yoke having a first side, a second side and an annular external surface, the first side and the second side opposite to each other, the annular external surface located between the first side and the second side, the plurality of winding sets wound on the stator yoke and protruding from the first side and the second side of the stator yoke; wherein the at least one guiding channel of the casing is located close to the annular external surface, and the at least one guiding channel extends from a part of the plurality of winding sets protruding from the first side to another part of the plurality of winding sets protruding from the second side;
a rotor, being rotatably disposed in the stator yoke; and
a first coolant guiding structure, being disposed close to the plurality of winding sets of the stator and an inlet channel of the casing, the first coolant guiding structure having at least one first radially guiding channel and at least one first axially guiding channel, the at least one first axially guiding channel connected to the inlet channel of the casing and the at least one guiding channel of the casing in order to receive and guide coolant into the at least one guiding channel of the casing, two ends of the at least one first radially guiding channel, which are opposite to each other, respectively having a first radial inlet and a first radial outlet, the first radial inlet connected to the at least one first axially guiding channel in order to receive coolant from the at least one first axially guiding channel, and the first radially guiding channel aligned with at least one of the plurality of winding sets in order to supply coolant to the plurality of winding sets.
